(19) United States
(12) Patent Application Publication
(10) Pub. No.: US 2026/0071665 A1
(43) Pub. Date: Mar. 12, 2026

(54) RADIAL VIBRATION ISOLATOR

(71) Applicant: PHOS GLOBAL ENERGY SOLUTIONS, INC., Fort Lauderdale, FL (US)

(72) Inventors: Eugene Earle Rudolph, Port Jefferson Station, NY (US); Victor Bica, Saint James, NY (US)

(73) Assignee: PHOS GLOBAL ENERGY SOLUTIONS, INC., Fort Lauderdale, FL (US)

(21) Appl. No.: 19/325,321

(22) Filed: Sep. 10, 2025

Related U.S. Application Data
(60) Provisional application No. 63/693,155, filed on Sep. 10, 2024.

(51) Int. Cl. F16F 15/315

(52) U.S. Cl. CPC F16F 15/3156; F16F 2224/02; F16F 2230/0029; F16F 2234/02

(57) ABSTRACT

A flywheel system including a flywheel assembly having a top plate, a bottom plate, a housing, and a flywheel suspended within the housing between the top plate and the bottom plate, a first spindle operatively associated with the flywheel and the bottom plate, a first bearing, secured in the bottom plate and configured to receive a portion of the first spindle, a second spindle operatively associated with the flywheel and the top plate, a second bearing, secured in the top plate and configured to receive a portion of the second spindle, a first rotational vibration isolator operatively associated with the first spindle and the first bearing, and a second rotational vibration isolator operatively associated with the second spindle and the second bearing, the first rotational vibration isolator and second rotational vibration isolator align the center of mass of the flywheel with an axial centerline of the flywheel.

### TECHNICAL FIELD

This disclosure generally relates to a vibration isolation and particularly to vibration isolation devices for use with high-speed high-mass rotating machinery.

### BACKGROUND

In the manufacture of rotating machinery, e.g., pumps, motors, etc. there is often a balancing process which is undertaken. The purpose of the balancing is to align the center of mass of the rotating component of the motor, pump, etc., with the rotating component's axial center. This may be done by adding or removing weight from the rotating component.

Balancing of the rotating component reduces impact loading on bearings and other elements of the pump or motor that support rotating component as the rotating component spins. As will be appreciated, a pump or motor spinning at 1800 or 3600 RPM, will result in vibrations caused by thousands of impacts on the bearing (e.g., ball or roller bearings) in the direction of the imbalance each minute of operation per-minute. Most machinery is configured for continuous operation for hours and even days without operation thus, the effects of these impacts, the vibration, acts to greatly reduce the life of the bearings and the time the equipment can operate before requiring maintenance. In addition, these vibrations propagate through the entire device and to other equipment and structures generating unnecessary and uncomfortable sounds, etc.

Despite the effects of the balancing operation (typically a machining process) imbalances remain. For example, even if a tolerance of 0.001 of an inch is achieved, the impact loading, through greatly reduced is not eliminated. This disclosure seeks to further reduce or eliminate the effects of a center of mass being misaligned with an axial center of rotating machinery.

### SUMMARY

One aspect of the disclosure is directed to a rotational vibration isolator including a body having a bore therethrough; and a plurality of curved arms extending from the body.

Implementations of this aspect of the disclosure may include one or more of the following features. The rotational vibration isolator where each of the plurality of curved arms has a tapered profile. Each of the plurality of curved arms has a greater thickness at a root of the curved arm and a narrower thickness at a tip of the curved arm. Each of the plurality of curved arms has a swept back profile. The swept back profile is in a direction of rotation of the rotational vibration isolator. The swept back profile opposite a direction of rotation of the rotational vibration isolator. The rotational vibration isolator including one or more of aluminum, steel, stainless steel, copper, beryllium copper, and combinations thereof. The bore is configured to receive a shaft of a piece of rotating machinery, and the plurality of curved arms are configured to be received in an inner race of a bearing. The bore is configured to receive an outer race of a bearing of a piece of rotating machinery. Flexure the plurality of curved arms aligns a center of mass of a piece of rotating machinery with an axial centerline of the piece of rotating machinery.

A further aspect of the disclosure is directed to a flywheel system including a flywheel assembly having a top plate, a bottom plate, a housing, and a flywheel suspended within the housing between the top plate and the bottom plate; a first spindle operatively associated with the flywheel and the bottom plate. The system also includes a first bearing, secured in the bottom plate and configured to receive a portion of the first spindle; a second spindle operatively associated with the flywheel and the top plate. The system also includes a second bearing, secured in the top plate and configured to receive a portion of the second spindle; a first rotational vibration isolator operatively associated with the first spindle and the first bearing; and a second rotational vibration isolator operatively associated with the second spindle and the second bearing, where the first rotational vibration isolator and second rotational vibration isolator align the center of mass of the flywheel, first spindle, and second spindle, with an axial centerline of the flywheel.

Implementations of this aspect of the disclosure may include one or more of the following features. The flywheel assembly where the first rotational vibration isolator and second rotational vibration isolator each include: a body having a bore therethrough; and a plurality of curved arms extending from the body. The first rotational vibration isolator is configured to receive a portion of the first spindle within the bore. The first rotational vibration isolator is configured for mounting within an inner race of the first bearing. The first rotational vibration isolator is configured for receiving an outer race of the first bearing. Each of the plurality of curved arms has a tapered profile. Each of the plurality of curved arms has a greater thickness at a root of the curved arm and a narrower thickness at a tip of the curved arm. Each of the plurality of curved arms has a swept back profile. The first rotational vibration isolator and the second rotational vibration isolator include one or more of aluminum, steel, stainless steel, copper, beryllium copper, and combinations thereof. The flywheel assembly further including a magnetic lift bearing configured for integration with the first spindle and a magnetic levitating bearing configured for integration with the second spindle.

### BRIEF DESCRIPTION OF THE DRAWINGS

FIG. 1A is a perspective view of a rotational vibration isolator in accordance with aspects of the disclosure;

FIG. 1B is a perspective view of a rotation vibration isolator mounted on a shaft and in a bearing in accordance with the disclosure;

FIG. 2 is a cross-sectional view of a flywheel system in accordance with the disclosure;

FIG. 3 is a cross-sectional view of a top portion of a flywheel assembly in accordance with the disclosure;

FIG. 4 is a cross-sectional vie of a bottom portion of a flywheel assembly in accordance with the disclosure;

FIG. 5 is a front view of a rotational vibration isolator in accordance with the disclosure;

FIG. 6 is a perspective view of a rotational vibration isolator in accordance with the disclosure;

FIG. 7 is a perspective view of a rotational vibration isolator in accordance with the disclosure;

FIG. 8 is a perspective view of a rotational vibration isolator in accordance with the disclosure.

### DETAILED DESCRIPTION

This disclosure is directed to a vibration isolator, particularly a vibration isolator for high-speed rotating machinery. In one implementation of the disclosure, the vibration isolator is employed in connection with a flywheel having a weight of between 4000 and 8000 lbs. and rotating at between 5000 and 15000 RPM.

Flywheels have been employed in a variety of settings to provide energy storage. Most internal combustion engines include some form of a flywheel which stores energy from the power stroke of one or more of the pistons and forces the crank shaft to continue its rotation until more energy is imparted by the next power stroke. This is particularly beneficial where there may be relatively long periods of time between power strokes (e.g., a single piston engine). In other settings, flywheels are coupled to energy sources (e.g., photovoltaic solar panels, wind turbines, or natural gas or diesel generators, etc.) and store energy for future use.

In one example, a flywheel may store 25 kW-hr of energy. A typical single-family US home of approximately 2000 square feet may use between 25 and 40 kW-hr of energy per day. A photovoltaic solar panel installation on the roof may generate between 30 and 40 kW-hr of energy per day (during an average summer day). However, much of that usage occurs during the early morning, evening, and nighttime hours, times when little to no energy is being produced by the solar panels. Thus, even though the solar panels can produce sufficient energy to power the house (most days) there is a usage and production disparity that requires some form of energy storage to overcome.

Batteries have been a common energy storage solution, but they are not without their drawbacks. Traditional lead-acid batteries have limited capacity, and require significant maintenance, particularly when regularly charging and discharging. Newer lithium-ion batteries require less maintenance, but have a relatively short lifespan (e.g., about 5 years when charged and discharged at high frequency (e.g., daily). Further lithium-ion batteries require materials that are relatively scarce and often can only be sourced in countries employing near slave labor tactics and via methods that are anything but environmentally friendly. Still further, the batteries themselves present environmental challenges both in their recycling (where available) and in their potential to enter an uncontrollable combustion state. Indeed, many apartment buildings and parking garages will not allow the installation of charging facilities in their parking structures for fear of a battery fire that could engulf the entire property and endanger many lives.

Flywheels provide an energy storage solution that can bridge the production and usage disparity without the environmental and maintenance challenges of batteries. Nonetheless, despite the lack of environmental and maintenance challenges, flywheels, which as noted above may weigh up to 8,000 lbs. and spin at up to 15,000 RPM are not without their challenges. One of the challenges of all rotating machinery is vibration, and those challenges only increase with high mass rotating at high speeds.

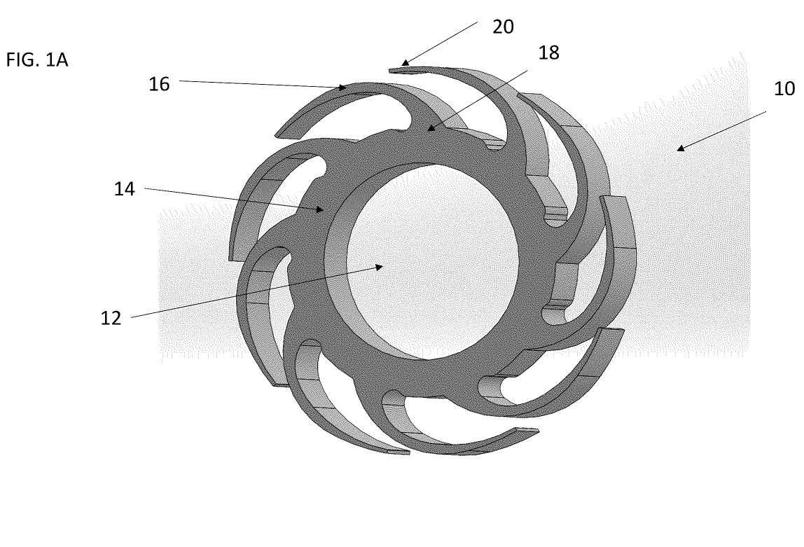

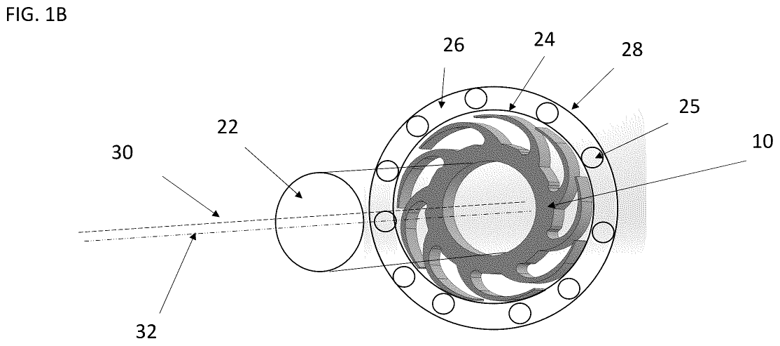

FIG. 1A depicts a rotational vibration isolator 10 in accordance with the disclosure. The rotational vibration isolator 10 includes a bore 12 surrounded by a body 14. Extending from the body 14 are a plurality of curved arms 16. The curved arms 16 have a tapered profile, where the curved arm has a wider root 18 that tapers to a narrower tip 20. In FIG. 1 the curved arms are formed in a swept back orientation with respect to the direction of rotation such that a direction from the root 18 to the narrower tip 20 is opposite the direction of rotation. Alternatively, the swept back orientation is such that the direction from the root 18 to the narrower tip 20 is in the direction of rotation. Further, other shapes are contemplated within the scope of the disclosure.

The rotational vibration isolator 10 may be made of a variety of materials including mild steel, stainless steel, copper, nickel, aluminum, and alloys of any of these including for example beryllium copper. The shape of the rotational vibration isolator 10 may be cut to the desired shape using water jet and other high tolerance cutting techniques. After cutting of the shape of the rotational vibration isolator 10 (e.g., via water jet), the bore 12 may reamed, cut on a lathe, or milled to produce a high tolerance bore 12.

The bore 12 is machined to a high tolerance such that it must be thermally fit on a shaft of a rotating component or on an outer race of a ball bearing or roller bearing set. The thermal fit (e.g., by heating the rotational vibration isolator 10 and optionally cooling the shaft or bearing) results in a small change (increase) in the diameter of the bore 12 and a small change (decrease) in the diameter of the shaft of bearing. These small changes in diameter are enough to allow the rotational vibration isolator 10 to slide over the shaft or bearing race. Once the temperature of the two components stabilizes and return to ambient, the changes in diameter reverse resulting in a high friction fit of the rotational vibration isolator 10 to the shaft or bearing race. Likewise, the curved arms 16 may form a gap or interference fit with their outer constraining bore. A gap or interference fit (pre-loading the spring) may influence the vibration response of the system and may reduce wear on the curved arms 16. The curved arms 16 may provide frictional (coulomb) damping of vibrations in the axial direction of the rotating mass of the flywheel.

As noted above, and as shown in FIG. 1B the rotational vibration isolator 10 may be mounted directly on a shaft 22 of a rotating machine such as a pump, motor, or flywheel. The combination of the rotational vibration isolator 10 and shaft 22 are mounted within an inner race 24 of bearing 26. However, in other applications, the rotational vibration isolator 10 may be mounted on the outer race 28, while the inner race 24 receives and is fitted to the shaft 22.

Referring to FIG. 1B, the axial centerline of the shaft 30 is not aligned with the center of mass 32 of the shaft 22 and everything attached to the shaft (e.g., motor windings, pump impeller, flywheel rotor, etc.). As a result of the misalignment, with each rotation of the shaft 22, rather than spinning on the axial centerline 30, the shaft spins on the center of mass 32. This results in an outward force on the balls or rollers 25 of the bearing 26 causing loading (compression) and unloading of the bearings 25 between the inner race 24 and the outer race 28. The force of that loading eventually results in a breakdown of the bearings 26, and particularly the balls or rollers 25.

The rotational vibration isolator 10, and in this example, the curved arms 16 compress in the direction of the force applied by the misalignment of the axial centerline 30 and the center of mass 32. This compression of the curved arms 16 brings reduces the impact of the force on the balls or rollers 25, as the shaft rotates each curved arm 16 compresses and decompresses as it is loaded and unloaded, however, because of their compressibility the effect of the misalignment is mitigated and the misalignment is effectively isolated from the bearing 26. By isolating the misalignment and minimizing the force of the impact of the misalignment on the inner race 24 and balls or rollers 25, any vibration caused by the misalignment is reduced. The bearing 26 can only experience a radial force equal to the product of the spring rate and spring deflection. Further, because the forces impacting the bearings 26 are reduced the size of bearings for any given application may also be reduced resulting in cost savings, energy savings, as well as a reduction in maintenance of the bearings 26.

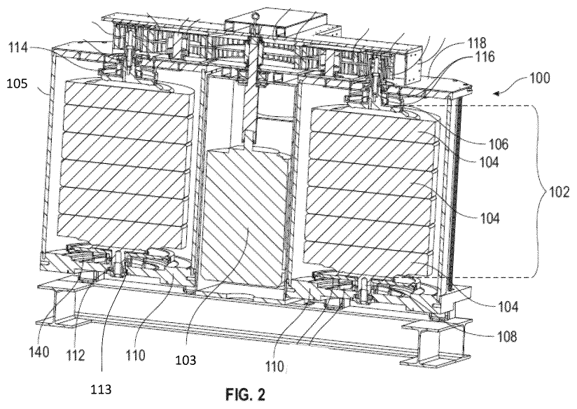

A further aspect of the disclosure is directed to a flywheel system 100 as shown in FIG. 2. The flywheel system 100 includes two flywheels 102 driven by a single motor 103. Each flywheel 102 includes multiple flywheel segments 104, each flywheel segments 104 is disposed in a stacked configuration such that a lower surface of a first flywheel segment 104 abuts or otherwise contacts an upper surface of an adjacent flywheel segment 104. Each flywheel segment 104 is coupled to one another using any suitable means, such as welding, adhesives, fasteners, amongst others. Where welding is employed, each flywheel segment 104 is coupled to one another by laser welding, electron beam welding, etc.

Continuing with FIG. 2, the flywheel 102 is disposed within a flywheel enclosure 105. The flywheel enclosure 105 may be formed of a steel pipe or other suitable material capable of maintaining a deep vacuum (e.g., approaching 0 psi, 29.9 in Hg, etc.) when appropriately sealed. The flywheel enclosure 105 mates with a base plate 110 and one or more rubber sealing rings (not shown) may be employed to ensure a substantially air-tight fit between the flywheel enclosure 105 and the base plate 110. A bore 112 in the base plate 110 is configured to receive a portion of a bottom spindle 108 and a bearing 113 (e.g., a ball or roller bearing) is employed in the bore 112 to receive the portion of the bottom spindle 108 and take up any lateral forces.

Mounted on the top spindle 106 of each flywheel 102 is a magnetic lift bearing 114. The magnetic lift bearing 114 is formed of two halves 116. A lower half 116 is secured to a top surface of spindle 106, and an upper half 116 may be secured to a top plate 118 of the flywheel 102. The top plate 118 along with bottom plate 110 complete the flywheel enclosure 105 and form a vacuum tight space in which the flywheel 102 rotates substantially free of friction. The spindle 106 extends into a recess 119 in the top plate 118 and a bearing (e.g., ball or roller bearing) 120 receives a portion of the top spindle 106 and takes of the lateral or radial loads of the flywheel 102.

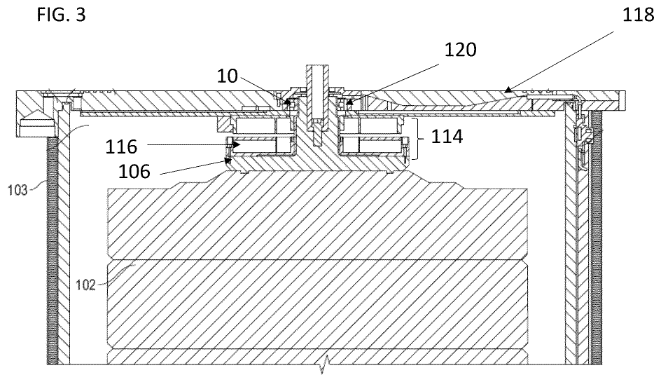

FIG. 3 depicts the top portion of the flywheel 102 and particularly some details relating to the magnetic lift bearing 114, the spindle 106, and the bearing 120. In accordance with an aspect of the disclosure, mounted to the spindle 106 and within an inner race of bearing 120 is a rotational vibration isolator 10, substantially in the configuration depicted in FIG. 1B. Alternatively, the rotational vibration isolator 10 may be secured to the outer race of the bearing 120 and secured within the recess in the top plate 118. In either orientation, as described above the rotational vibration isolator 10 substantially eliminates or at least significantly reduces the transmission of vibrations from the rotating flywheel 102. Importantly, though the flywheel 102 may be balanced such balancing often occurs prior to the addition of features such as the spindle 106 and the lower half 116 of the magnetic lift bearing 114. The addition of these elements can change the center of mass of the flywheel 102 thus resulting in the misalignment described above, the addition of the rotational vibration isolator 10 to the bearing 120 reduces and substantially eliminates this misalignment, or the effects of the misalignment.

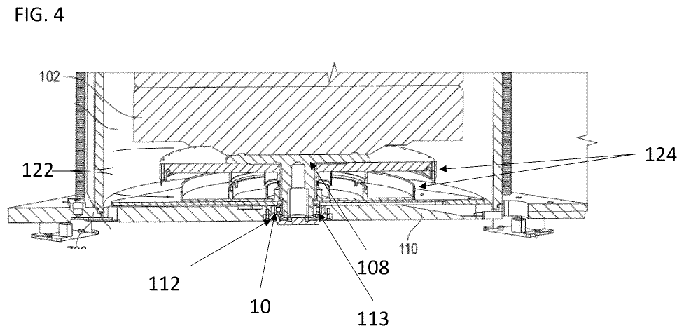

Similarly, FIG. 4 depicts a detailed view of the lower portion of the flywheel 102 and the area around the bore 112 in the base plate 110 that receives the bottom segment 108 and a bearing 113 (e.g., a ball or roller bearing). A magnetic lift bearing 122 is formed of two halves 124. A top half 124 is mounted on the bottom spindle 108 and therewith the flywheel, while a bottom half is either mounted to or formed as part of the base plate 110. The bearing 113 is mounted to the bottom spindle 108 and fit within a recess formed in the base plate 110. As with the bearing 120, described above, a rotational vibration isolator 10 may be mounted within the inner race of the bearing 113 and configured to receive a portion of the bottom spindle 108. Alternatively, the rotational vibration isolator 10 may be mounted on the outer race of bearing 113 and secured within the recess in the base plate 110. Again the rotational vibration isolator 10 allows for any misalignment between the center of mass of the flywheel 102 and the axial center of the flywheel to be addressed, particularly any misalignment caused by the addition of the bottom spindle 108 and the top half 124 of the magnetic lift bearing 122.

A bottom half 124 of the magnetic levitating bearing 122 is substantially identical to the top half 124. However, unlike the magnetic lifting bearing 114, where the goal is to attract the two halves 116 together, and thus opposing polarities of the magnets of the bottom half 116 and the top half 116 are aligned, a bottom half 124 of magnetic levitating bearing 122 has an identical arrangement of magnets. In this way, the top half 124, which may be mounted to the bottom spindle 108, has its magnetic polarities aligned with and directly opposing the magnetic the magnetic polarities of the bottom half 124. These opposing magnetic polarities (i.e., the same polarities facing one another) force the flywheel 102 away from the base plate 110, lifting the flywheel 102 in the direction of the top plate 118. Thus, in accordance with one aspect of the disclosure, the flywheel 102 in the flywheel housing 105 is held weightless relative to the bearings 120 and 113. This in combination with the use of a rotational vibration isolator 10 in combination with the bearings 120 and 113 result in a near limitless lifespan of the bearings and substantially reduces or eliminates vibration of the flywheel 102, despite spinning at between 5,000 and 12,000 RPM.

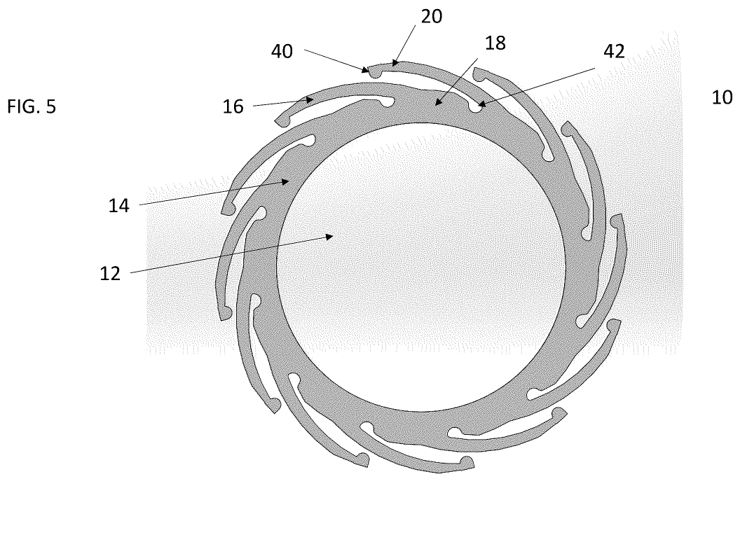

FIG. 5 depicts a version of the rotational vibration damper 10. The rotational vibration damper includes a snubber geometry. The snubber geometry includes a snub end 40 on the distal portion of the curved arm 16 that can limit deflection of the curved arms 16 in the direction of the body 14 and thus limiting bending stresses in the curved arms 16. Similarly a relief 42 which may, as shown generally, have a similar shape to the snub end 40 may be formed in the body 14 at the base of the curved arm 16. The relief 42 changes the location of the center of rotation or about which the curved arms 16 bend.

Though described hereinabove as a single rotational vibration damper 10 being deployed on a single shaft 22 or bearing 26, the disclosure is not so limited and two or more vibration dampers 10 may be employed. In one example, two vibration isolation dampers 10, each with either the same or different flex characteristics are employed between a shaft 22 and an inner race 24 of bearing 26. Similarly, the two rotational vibration dampers 10, having either the same flexure or differing flexure can be mounted on the outer race 28 of the bearing 26. Additionally, or alternatively, when the rotational vibration damper 10 is placed on the outer race 28 of bearing 26, the combination may placed inside an inner race of yet another bearing 26. The second bearing 26 may be a safety or emergency bearing that is only ever loaded if the first bearing were to fail.

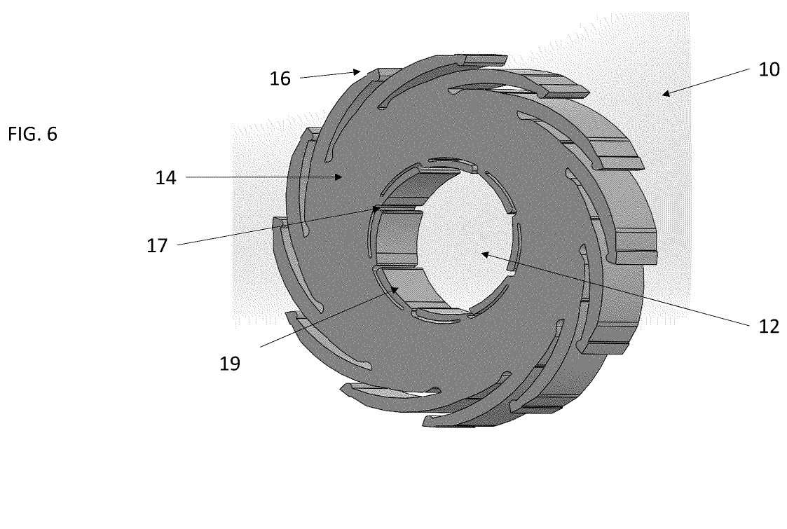

Still a further aspect of the disclosure is depicted in FIG. 6. The rotational vibration damper 10, the curved arms 16 are as described herein above and are configured to act on an inner race 24 of a bearing 26 (See FIG. 2). In contrast with FIG. 2, the aspect of the disclosure depicted in FIG. 6 also includes inner curved arms 17 formed on an inner diameter of the rotational vibration damper 10 and extending from the body 14. As shown the inner curved arms 17 are configured to receive a shaft 22 of a flywheel (or motor). The inner curved arms 17 may have the same dimensions and rigidity as the curved arms 16, or as shown, may have different dimensions and thus flex and absorb vibrations at different magnitudes, frequencies, harmonics, speeds, temperatures, etc., than the curved arms 16. Though shown with inner curved arms 17 and curved arms 16 having the same orientation, the disclosure is not so limited, and the orientations may be opposite of one another without departing from the scope of the disclosure. The inner curved arms 17 may be arranged such that an inner surface 19 receives a shaft 22 in a friction fit to prevent relative movement of the shaft 22 and the rotational vibration damper 10.

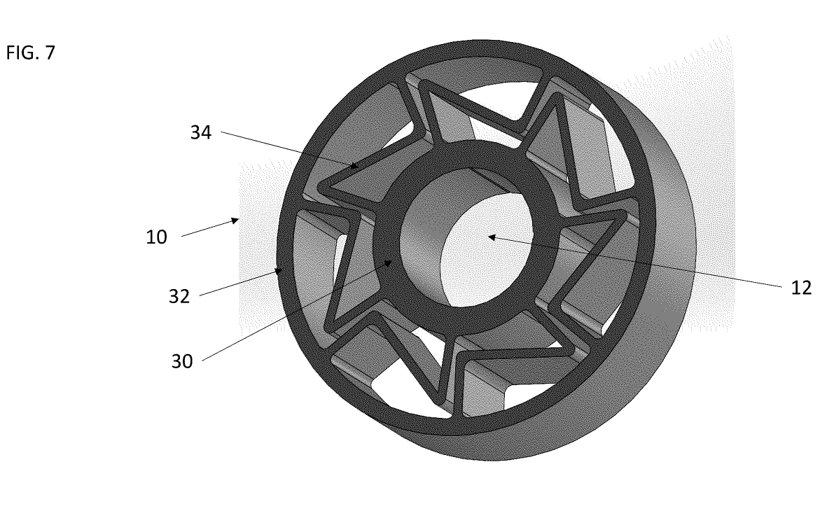

Still a further aspect of the disclosure is depicted in FIG. 7. The rotational vibration damper 10 includes a bore 12 for receiving either a shaft (e.g., of a motor or flywheel) or an outer race 28 of a bearing 26. The bore 12 is defined by an inner body 30 and outer body 32. In some instances, the outer body 32 may be received within a bearing 26, as described herein above. Angled flexure arms 34 connect the inner body 30 with the outer body 34. As with other embodiments herein, vibrations from rotating machinery (e.g., motors, flywheels, etc.) are transferred from the inner body 30 and absorbed by the angled flexure arms 34 and the transfer of vibrations to the outer body 32 is limited. In this manner, the vibrations caused by misalignment and imbalances of high-speed rotating machinery can be reduced or eliminated.

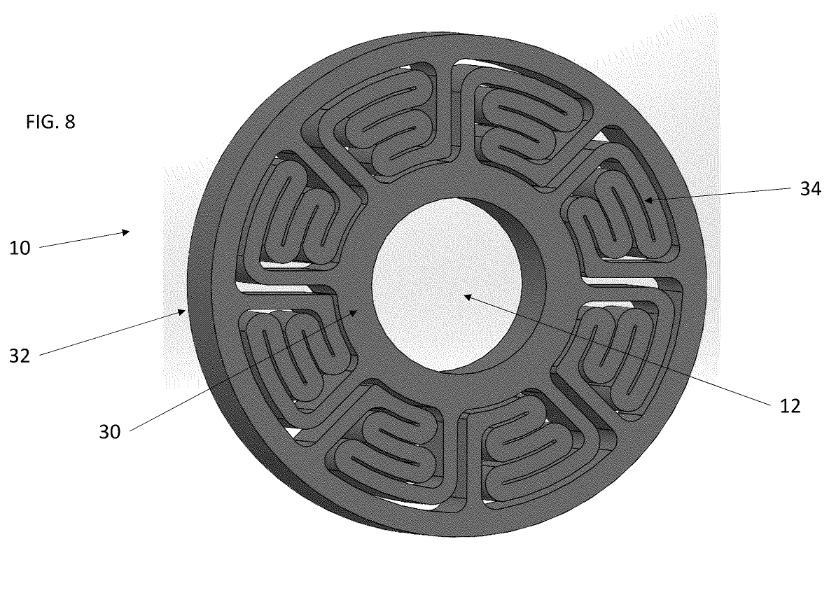

FIG. 8 depicts yet a further aspect of the disclosure, wherein the flexure arms 34 are formed in a serpentine configuration. The vibration damper of FIG. 8, and other examples herein, may be formed via wire electrical discharge machining (EDM) and like FIG. 7 has built in limits to travel of the inner race 30 relative to the outer race 32 due to the flexure arms 34 being connected to both.

As with other embodiments described herein, the rotational vibration damper 10 of FIGS. 6, 7, and 8 may be secured to a shaft (e.g., of a motor or flywheel) received within the bore 12 and within an internal diameter (inner race 24) of a bearing 26 (as depicted in FIG. 1B). Additionally or alternatively, the rotational vibration damper 10 may receive the outer race 28 of the bearing 26 within the bore 12. The bearing 26 being secured to the shaft. Further, both orientations may be employed with one rotational vibration damper 10 being secured to the inner race 24 and one secured to the outer race 28, each of which may have different damping characteristics without departing from the scope of the disclosure.

It will be understood that various modifications may be made to the embodiments of the presently disclosed renewable energy generation systems. Therefore, the above description should not be construed as limiting, but merely as exemplifications of embodiments. Those skilled in the art will envision other modifications within the scope and spirit of the present disclosure.

We claim:

1. A rotational vibration isolator comprising:
a body having a bore therethrough; and
a plurality of curved arms extending from the body.

2. The rotational vibration isolator of claim 1, wherein each of the plurality of curved arms has a tapered profile.

3. The rotational vibration isolator of claim 2, wherein each of the plurality of curved arms has a greater thickness at a root of the curved arm and a narrower thickness at a tip of the curved arm.

4. The rotational vibration isolator of claim 2, wherein each of the plurality of curved arms has a swept back profile.

5. The rotational vibration isolator of claim 4, wherein the swept back profile is in a direction of rotation of the rotational vibration isolator.

6. The rotational vibration isolator of claim 4, wherein the swept back profile opposite a direction of rotation of the rotational vibration isolator.

7. The rotational vibration isolator of claim 1 comprising one or more of aluminum, steel, stainless steel, copper, beryllium copper, and combinations thereof.

8. The rotational vibration isolator of claim 1, wherein the bore is configured to receive a shaft of a piece of rotating machinery, and the plurality of curved arms are configured to be received in an inner race of a bearing.

9. The rotation vibration isolator of claim 1, wherein the bore is configured to receive an outer race of a bearing of a piece of rotating machinery.

10. The rotational vibration isolator of claim 1, wherein flexure the plurality of curved arms aligns a center of mass of a piece of rotating machinery with an axial centerline of the piece of rotating machinery.

11. A flywheel system comprising:
a flywheel assembly including a top plate, a bottom plate, a housing, and a flywheel suspended within the housing between the top plate and the bottom plate;
a first spindle operatively associated with the flywheel and the bottom plate;
a first bearing, secured in the bottom plate and configured to receive a portion of the first spindle;
a second spindle operatively associated with the flywheel and the top plate;
a second bearing, secured in the top plate and configured to receive a portion of the second spindle;
a first rotational vibration isolator operatively associated with the first spindle and the first bearing; and
a second rotational vibration isolator operatively associated with the second spindle and the second bearing, wherein the first rotational vibration isolator and second rotational vibration isolator align the center of mass of the flywheel, first spindle, and second spindle, with an axial centerline of the flywheel.

12. The flywheel assembly of claim 11, wherein the first rotational vibration isolator and second rotational vibration isolator each include:
a body having a bore therethrough; and
a plurality of curved arms extending from the body.

13. The flywheel assembly of claim 12, wherein the first rotational vibration isolator is configured to receive a portion of the first spindle within the bore.

14. The flywheel assembly of claim 13, wherein the first rotational vibration isolator is configured for mounting within an inner race of the first bearing.

15. The flywheel assembly of claim 13, wherein the first rotational vibration isolator is configured for receiving an outer race of the first bearing.

16. The flywheel assembly of claim 12, wherein each of the plurality of curved arms has a tapered profile.

17. The flywheel assembly of claim 16, wherein each of the plurality of curved arms has a greater thickness at a root of the curved arm and a narrower thickness at a tip of the curved arm.

18. The flywheel assembly of claim 16, wherein each of the plurality of curved arms has a swept back profile.

19. The flywheel assembly of claim 12, wherein the first rotational vibration isolator and the second rotational vibration isolator comprise one or more of aluminum, steel, stainless steel, copper, beryllium copper, and combinations thereof.

20. The flywheel assembly of claim 12 further comprising a magnetic lift bearing configured for integration with the first spindle and a magnetic levitating bearing configured for integration with the second spindle.
